(19) United States
(12) Patent Application Publication
(10) Pub. No.: US 2025/0365573 A1
(43) Pub. Date: Nov. 27, 2025

(54) PROVIDING AN AUTHENTICATION TOKEN FOR AUTHENTICATION OF A USER DEVICE FOR A THIRD-PARTY APPLICATION USING AN AUTHENTICATION SERVER

(71) Applicant: Telefonaktiebolaget LM Ericsson (PUBL), Stockholm (SE)

(72) Inventor: Christian OLROG, Stockholm (SE)

(21) Appl. No.: 18/874,728

(22) PCT Filed: Jun. 20, 2022
(86) PCT No.: PCT/SE2022/050604

§ 371 Date: Dec. 13, 2024

(51) Int. Cl. H04W 12/0431; H04L 9/40; H04W 12/069

(52) U.S. Cl. CPC H04W 12/0431; H04L 63/083; H04W 12/069

(57) ABSTRACT

It is provided a method for providing an authentication token for authentication of a user device (2) for a third-party application. The method is performed by an authentication server (1) of a cellular network (8). The method comprises: receiving (40) a request for an authentication token from a user device (2) over a channel in the cellular network (8), the request comprising an identifier at least temporarily associated with the user device (2); validating (42) that the identifier is associated with the cellular network (8); generating (46) an authentication token, comprising cryptographically applying a key of the authentication server (1), resulting in an authentication token being a data item; and providing (48) the authentication token to the user device (2).

### TECHNICAL FIELD

The disclosure relates to the field of authentication and in particular to providing an authentication token for authentication of a user device for a third-party application.

### BACKGROUND

Authentication of a user in a software application has been used for decades to secure software applications and to provide data that is specific to the user. Traditionally, a user logs in with a username and a password. Additional factors of authentication, e.g. one-time codes can be communicated using an e-mail or text message can be used to enhance security.

Relatively recently, the authentication process has been streamlined such that, when a user logs in to a third-party application, the authentication occurs with an authentication server of a separate authentication provider. This reduces the number of accounts for the user, while the third-party application can ensure the user is authenticated and can provide data that is specific for the user. This process is sometimes referred to as single sign on (SSO).

The authentication server can be provided by any suitable authentication provider that is considered reliable, such as a social networking platform (e.g. Facebook), or an enterprise platform (e.g. Microsoft Office 365). This type of authentication is supported e.g. by SAML (security assertion markup language) version 1.0 or later, or OAuth (open authorization), version 1.0 or 2.0 (IETF RFC 6749). For this process, a user device first interacts with the authentication provider to retrieve tokens that are subsequently used when interacting with the third-party application. When the user logs in to the authentication provider (e.g. Microsoft Office 365), the user device is first redirected from the third-party application to a login page, which is in fact provided by the authentication provider. After successfully proving identity to the authentication provider, the user device receives an authentication token from the authentication server, and is redirected back to the third-party application. The third-party application then uses the authentication token to validate that the user has been properly authenticated by the authentication provider and receives an authenticated identity.

This process increases security since the authentication provider can be one of a few entities that the user may trust more, to provide increased security. For instance, the user may trust that Microsoft is better suited than a little local web shop to manage security and avoid hacker attacks. In this process, the local web shop at least does not store any password data (neither in plain text nor hashed) that would need to be the case if the third-party application were to completely manage the user accounts.

Even with the improvement in modern authentication solutions, it would be of great benefit if the login process is made more user-friendly, yet secure.

### SUMMARY

One object is to improve the user experience for authentication for a third-party application.

According to a first aspect, it is provided a method for providing an authentication token for authentication of a user device for a third-party application. The method is performed by an authentication server of a cellular network. The method comprises: receiving a request for an authentication token from a user device over a channel in the cellular network, the request comprising an identifier at least temporarily associated with the user device; validating that the identifier is associated with the cellular network; generating an authentication token, comprising cryptographically applying a key of the authentication server, resulting in an authentication token being a data item; and providing the authentication token to the user device.

In one embodiment, the generating of the authentication token is only performed after successfully validating that the identifier is associated with the cellular network.

The validating may comprise: transmitting an evaluation request to a core network device, the evaluation request comprising the identifier; and receiving from the core network device a result indicating whether the identifier is associated with the cellular network.

The method may further comprise: receiving a set of at least one valid identifier that is associated with the cellular network and storing in a local list of identifiers that are associated with the cellular network. In this case, the validating comprises verifying that identifier is in the local list of identifiers that are associated with the cellular network.

The identifier may comprise an Internet Protocol, IP, address, in which case the validating comprises matching the IP address against a list of IP addresses associated with the cellular network.

The identifier may comprise a session identifier, identifying a session for the user device in relation to the cellular network, in which case the validating comprises determining that the session identifier is associated with the cellular network.

The identifier may comprise a subscriber identifier associated with the user device.

The method may further comprise: receiving the authentication token from a server application; validating the authentication token; and providing, to the server application, a result of the validation of the authentication token.

The validating may comprise ensuring that the user device is directly connected to the cellular network.

According to a second aspect, it is provided an authentication server configured to form part of a cellular network for providing an authentication token for authentication of a user device for a third-party application. The authentication server comprises: a processor; and a memory storing instructions that, when executed by the processor, cause the authentication server to: receive a request for an authentication token from a user device over a channel in the cellular network, the request comprising an identifier at least temporarily associated with the user device; validate that the identifier is associated with the cellular network; generate an authentication token, comprising cryptographically applying a key of the authentication server, resulting in an authentication token being a data item; and provide the authentication token to the user device.

The instructions to generate the authentication token may comprise instructions that, when executed by the processor, cause the authentication server to only generate the authentication token after successfully validating that the identifier is associated with the cellular network.

The instructions to validate may comprise instructions that, when executed by the processor, cause the authentication server to: transmit an evaluation request to a core network device, the evaluation request comprising the identifier; and receive from the core network device a result indicating whether the identifier is associated with the cellular network.

The authentication server may further comprise instructions that, when executed by the processor, cause the authentication server to: receive a set of at least one valid identifier that is associated with the cellular network and storing in a local list of identifiers that are associated with the cellular network, in which case the instructions to validate comprise instructions that, when executed by the processor, cause the authentication server to: verify that identifier is in the local list of identifiers that are associated with the cellular network.

The identifier may comprise an Internet Protocol, IP, address, in which case the instructions to validate comprise instructions that, when executed by the processor, cause the authentication server to match the IP address against a list of IP addresses associated with the cellular network.

The identifier may comprise a session identifier, identifying a session for the user device in relation to the cellular network, in which case the instructions to validate comprise instructions that, when executed by the processor, cause the authentication server to determine that the session identifier is associated with the cellular network.

The identifier may comprise a subscriber identifier associated with the user device.

The authentication server may further comprise instructions that, when executed by the processor, cause the authentication server to: receive the authentication token from a server application; validate the authentication token; and provide, to the server application, a result of the validation of the authentication token.

The instructions to validate may comprise instructions that, when executed by the processor, cause the authentication server to ensure that the user device is directly connected to the cellular network.

According to a third aspect, it is provided a computer program for providing an authentication token for authentication of a user device for a third-party application. The computer program comprises computer program code which, when executed on an authentication server of a cellular network causes the authentication server to: receive a request for an authentication token from a user device over a channel in the cellular network, the request comprising an identifier at least temporarily associated with the user device; validate that the identifier is associated with the cellular network; generate an authentication token, comprising cryptographically applying a key of the authentication server, resulting in an authentication token being a data item; and provide the authentication token to the user device.

According to a fourth aspect, it is provided a computer program product comprising a computer program according to the third aspect and a computer readable means comprising non-transitory memory in which the computer program is stored.

According to a fifth aspect, it is provided a method for enabling providing an authentication token for user authentication for a third-party application. The method is performed by a core network device of a cellular network also comprising an authentication server. The method comprises: attaching a user device to the cellular network; modifying a configuration such that any subsequent request from the user device to the authentication server for an authentication token, are routed via the cellular network; receiving an evaluation request comprising an identifier at least temporarily associated with the user device; evaluating whether the identifier is associated with the cellular network; and transmitting a result of the evaluating.

The modifying a configuration may comprise, when the user device supports a first connection via the cellular network in parallel with a second connection via a second network, adding a latency for connections to the authentication server over the second connection.

According to a sixth aspect, it is provided a core network device configured to form part of a cellular network also comprising an authentication server, for enabling providing an authentication token for user authentication for a third-party application. The core network device comprises: a processor; and a memory storing instructions that, when executed by the processor, cause the core network device to: attach a user device to the cellular network; modify a configuration such that any subsequent request from the user device to the authentication server for an authentication token, are routed via the cellular network; receive an evaluation request comprising an identifier at least temporarily associated with the user device; evaluate whether the identifier is associated with the cellular network; and transmit a result of the evaluating.

The instructions to modify a configuration may comprise instructions that, when executed by the processor, cause the core network device to, when the user device supports a first connection via the cellular network in parallel with a second connection via a second network, add a latency for connections to the authentication server over the second connection.

According to a seventh aspect, it is provided a computer program for enabling providing an authentication token for user authentication for a third-party application. The computer program comprises computer program code which, when executed on a core network device of a cellular network also comprising an authentication server, causes the core network device to: attach a user device to the cellular network; modify a configuration such that any subsequent request from the user device to the authentication server for an authentication token, are routed via the cellular network; receive an evaluation request comprising an identifier at least temporarily associated with the user device; evaluate whether the identifier is associated with the cellular network; and transmit a result of the evaluating.

According to an eighth aspect, it is provided a computer program product comprising a computer program according to the seventh aspect and a computer readable means comprising non-transitory memory in which the computer program is stored.

Generally, all terms used in the claims are to be interpreted according to their ordinary meaning in the technical field, unless explicitly defined otherwise herein. All references to “a/an/the element, apparatus, component, means, step, etc.” are to be interpreted openly as referring to at least one instance of the element, apparatus, component, means, step, etc., unless explicitly stated otherwise. The steps of any method disclosed herein do not have to be performed in the exact order disclosed, unless explicitly stated.

### BRIEF DESCRIPTION OF THE DRAWINGS

Aspects and embodiments are now described, by way of example, with reference to the accompanying drawings, in which:

FIG. 1 is a schematic diagram illustrating an environment where embodiments presented herein may be applied;

FIG. 2 is a sequence diagram illustrating communication between various entities of embodiments which can be applied in the environment of FIG. 1;

FIGS. 3A-C are flow charts illustrating embodiments of methods for providing an authentication token for authentication of a user device for a third-party application, performed by an authentication server;

FIG. 4 is a flow chart illustrating embodiments of methods for enabling providing an authentication token for user authentication for a third-party application, performed by a core network device;

FIG. 5 is a schematic diagram illustrating components of each one of the authentication server and the core network device of FIG. 1;

FIG. 6 is a schematic diagram showing functional modules of the authentication server of FIG. 1 according to one embodiment;

FIG. 7 is a schematic diagram showing functional modules of the core network device of FIG. 1 according to one embodiment; and

FIG. 8 shows one example of a computer program product comprising computer readable means.

### DETAILED DESCRIPTION

The aspects of the disclosure will now be described more fully hereinafter with reference to the accompanying drawings, in which certain embodiments of the invention are shown. These aspects may, however, be embodied in many different forms and should not be construed as limiting; rather, these embodiments are provided by way of example so that this disclosure will be thorough and complete, and to fully convey the scope of all aspects of invention to those skilled in the art. Like numbers refer to like elements throughout the description.

According to embodiments presented herein, the association of a user device and a cellular network is used as a sufficient condition for authentication for use with a third-party application. An authentication server of (e.g. a core network of the) the cellular network checks whether the user device is associated with the cellular network, in which case it generates an authentication token for use by the third-party application. The communication for authentication between the user device and the authentication server occurs over the cellular network (in other words, via other network devices of the cellular network), whereby the authentication server is able to check whether there is an association, e.g. an established security association, between the user device and the cellular network. Other communication from the user device does not need to be routed via the cellular network and can e.g. be routed over a Wi-Fi network, satellite network, or a non-3rd Partnership Project network connected to a wide area network (WAN) such as the Internet.

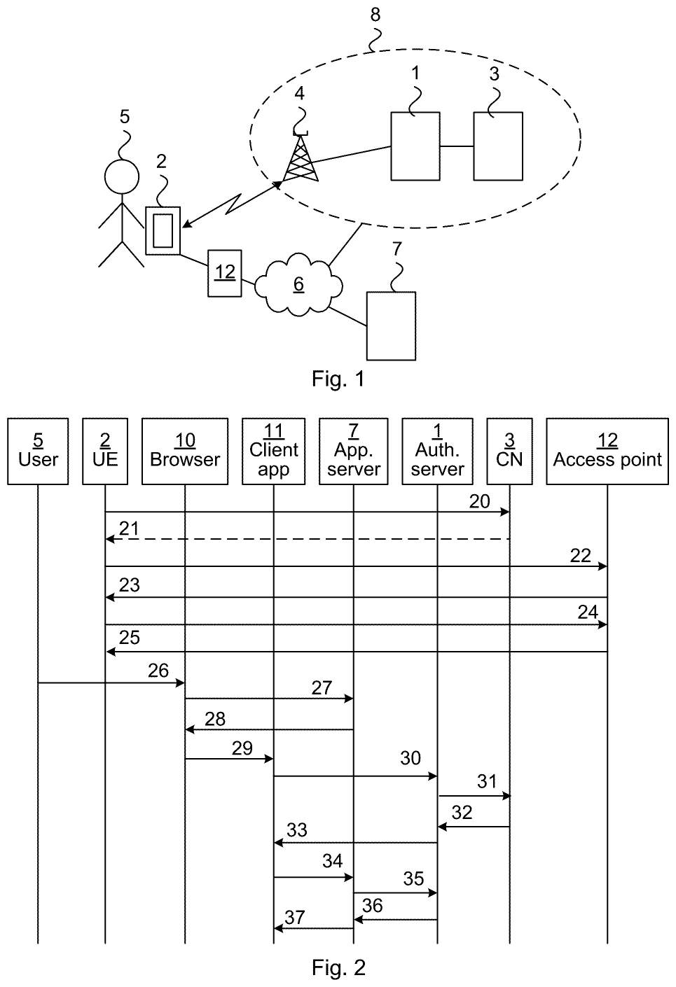

FIG. 1 is a schematic diagram illustrating an environment where embodiments presented herein may be applied. A cellular network 8 comprises a core network with one or more core network devices 3, an authentication server 1, and one or more radio network nodes 4, here in the form of radio base stations. Sometimes, the authentication server 1 is also known as an authorization server, especially when the server is used both for authentication and authorization. The authentication server 1 can be considered to form part of the core network of the cellular network 8 and can be implemented as an OAuth (open authorization) server. The radio network node 4 provides radio connectivity over a wireless interface to one or more user devices 2. The term user device 2 is also known as mobile communication terminal, user equipment (UE), wireless device, mobile terminal, user terminal, user agent, wireless terminal, machine-to-machine device etc., and can be, for example, what today are commonly known as a mobile phone, smart phone, or a tablet/laptop with wireless connectivity. The user device 2 is associated with a user 5, being a person that owns or otherwise has usage rights to the user device 2. Another example of the user device 2 is an Internet-of-Things (IoT) device, such as a rather sophisticated one like a vehicle, e.g. a boat, an airplane, a train, a car, a truck, and a bus. Yet another example of the user device 2 is a Virtual Reality/Augmented Reality (VR/AR) device like a VR or AR goggles or VR or AR glasses. Still other examples of the user device 2 are a gaming console and a robot.

The cellular network 8 may e.g. comply with any one or a combination of 6G, 5G NR (New Radio), LTE (Long Term Evolution), LTE Advanced, W-CDMA (Wideband Code Division Multiplex), 5GC (5G Core), EPC (Evolved Packet Core) or any other current or future wireless network, as long as the principles described hereinafter are applicable.

Over the wireless interface, downlink communication occurs from the radio network node 4 to the user device 2 and uplink communication occurs from the user device 2 to the radio network node 4. The quality of the wireless radio interface to each user device 2 can vary over time and depending on the position of the user device 2, due to effects such as fading, multipath propagation, interference, etc.

The user device 2 is also connected to a wide-area network (WAN) 6 such as the Internet, via an access point 12, which can e.g. rely on one of the IEEE 802.1x protocols, also known as Wi-Fi. An application server 7 is also connected to the WAN 6. The application server 7 hosts a third-party server application that uses token-based authentication for identifying user devices. The cellular network 8, and specifically the authentication server 1, is also connected to the WAN 6, e.g. via a gateway device.

The data communication in the cellular network 8 can occur over any suitable data protocol, e.g. Internet protocol (IP). Likewise, the data communication in the WAN 6 can occur over any suitable data protocol, e.g. the Internet protocol (IP).

FIG. 2 is a sequence diagram illustrating communication between various entities of embodiments which can be applied in the environment of FIG. 1. The sequence illustrates embodiments of authenticating a user device 2 for a third-party application.

The sequence starts by the user device 2 attaching/registering 20 to the cellular network 8, in communication with the core network device 3. Optionally, the core network device 3 responds to the user device 2 with a routing configuration 21 (e.g. using IPv6 router advertisement route options) such that any subsequent request from the user device 2 to the authentication server 1 (such as for an authentication token) are routed via the cellular network 8. The core network device 3, when responding with routing configuration in a 5G environment having the role of an SMF (Session Management Function).

The user device 2 also requests 22 to connect to the access point 12, e.g. using an SSID (service set identifier) connect command 22. The access point 12 responds with a confirmation 23 that a connection is established. The user device 2 transmits a request 24 (such as a DHCP (dynamic host configuration protocol) request) to obtain network connection parameters.

Both the cellular network (using i.a. the core network device 3) and the access point 12 can provide access to the WAN 6.

A browser 10 forms part of the user device 2 (i.e. is a browser software running on the user device 2), but is shown as a separate entity in FIG. 2 for reasons of clarity. When the user wants to use a third-party application, the user 5 provides user input 26 to the browser 10, e.g. using a virtual keyboard, clicking on a link or a bookmark, to thereby navigate to a web page referred to by a URI (uniform resource indicator). From the web page, the browser 10/user device 2 can send a request 27 to the application server 7, resulting in a client application 28 being downloaded from the application server 7. The client application is the client (user device) side of the third-party application. Once the client application is installed, the browser 10 can trigger 29 the client application 11 (corresponding to the download 28 from the application server 7) to execute.

After the client application 11 starts, it requests 30 an authentication token from the authentication server 1. It is to be noted that the authentication token is also known as an authorization token, especially when the token is used to indicate both authentication and authorization. The authentication token is also known as an access token. According to embodiments presented herein, this request 30 is routed over the cellular network 8 to the authentication server 1.

The authentication server 1 validates whether the user device 2 is associated with the cellular network 8, to thereby authenticate the user device. In one embodiment, this validation occurs in a pull-based algorithm, by the authentication server 1 transmitting an evaluation request 31 with an identifier of the user device 2 to the core network device 3. The core network device 3 then evaluates the identifier of the user device 2. The result 32 of this evaluation is then transmitted as a response back to the authentication server 1. Alternatively, in a push-based algorithm, the core network device 3 initiates communication of what identifiers are associated with the cellular network 8, either on a regular basis or whenever there are new identifiers or identifiers that should be removed. In an example of a 5GC embodiment, the core network device 3 is network device with a UDM (Unified Data Management) function and the authentication server 1 is a network device with an AUSF (Authentication Server Function).

Regardless of how the validation of the user device occurs 2, when the validation is successful, the authentication server 1 generates an authentication token for the user device 2. On the other hand, if the validation is unsuccessful, the procedure ends (not shown). The authentication token is a data item that indicates that an authentication of the user device is successful. The generation comprises cryptographically applying a key of the authentication server 1, yielding the authentication token 33 and transmitting the authentication token 33 to the client application 11.

The client application 11 can then provide a signal 34 to the application server 7, wherein the signal 34 comprises the authentication token. To authenticate the user device, the application server 7 sends 35 the authentication token to the authentication server 1. The authentication server 1 can then verify that the authentication token from the application server 7 is valid, and respond 36 to the application server 7 that the authentication token is valid. This allows the application server 7 to authenticate the user device 2, and respond 37 to the client application 11 with data (e.g. restricted data or data that is specific for the user) that relies on the user device being authenticated.

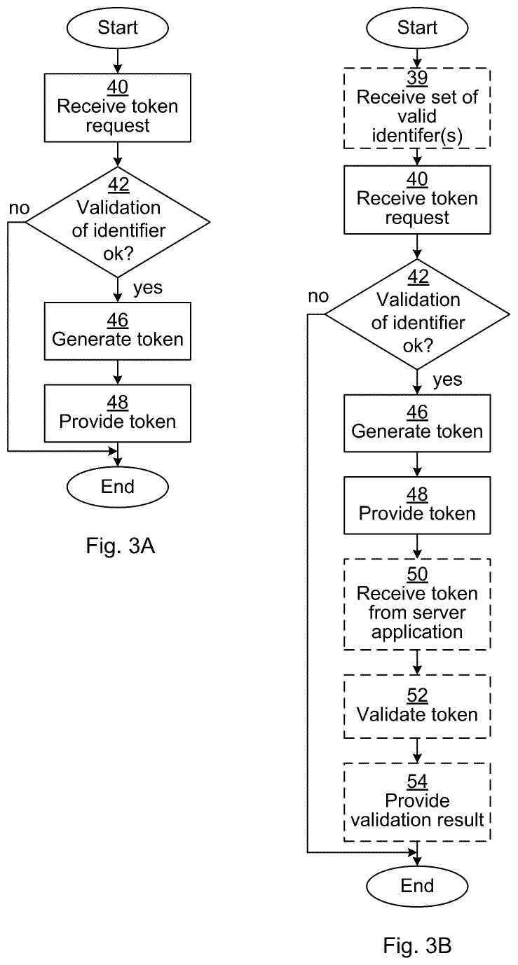

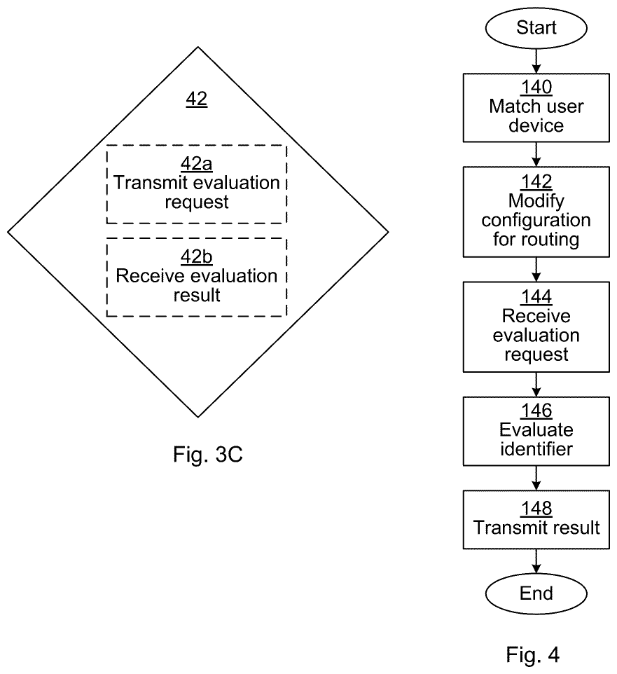

FIGS. 3A-C are flow charts illustrating embodiments of methods for providing an authentication token for authentication of a user device 2 for a third-party application. The method is performed by an authentication server 1 of a cellular network 8, e.g. as shown in FIG. 1 and FIG. 2. The embodiments of FIGS. 3A-C roughly correspond to the actions of the authentication server 1 illustrated in FIG. 2 and described above. First, embodiments illustrated by FIG. 3A will be described.

In a receive token request step, the authentication server 1 receives a request for an authentication token from a user device 2 over a channel in the cellular network 8. The request comprises an identifier at least temporarily associated with the user device 2. The identifier may comprise a subscriber identifier associated with the user/user device 2, such as a SUPI (subscription permanent identifier) in 5G or IMSI (international mobile subscriber identity) in 4G and may be sent from the user device 2 in a partly encrypted form, such as a SUCI (Subscription Concealed identifier) in 5G. In the case of a SUCI, the core network device 3 is in an embodiment the network node that would de-conceal the SUPI in the SUCI through a SIDF (Subscriber Identity De-concealing Function). Alternatively or additionally, the identifier comprises an IP address of the user device. Alternatively or additionally, the identifier comprises a session identifier, identifying a session for the user device in relation to the cellular network 8. While the subscriber identifier is more permanent and the IP address can be more transitory, both these parameters can be used to identify the user device 2 for the purposes described herein.

In a conditional validation of identifier ok step 42, the authentication server 1 validating whether the identifier is associated with the cellular network 8. If the identifier is validated to be associated with the cellular network 8, the method proceeds to a generate token step 46. Otherwise, the method ends.

When the identifier comprises an IP (internet protocol) address, the validating of the identifier (to check if is associated with the cellular network 8) comprises matching the IP address against a list of IP addresses associated with the cellular network. This validation can thus occur by matching the IP address of the user device against a list of the currently allocated IP address for sessions of user device that are associated with the cellular network.

When the identifier comprises a session identifier, the validating of the identifier (to check if is associated with the cellular network 8) comprises determining whether the session identifier is associated with the cellular network. This is one way of checking whether the user device is associated with the cellular network, since each session is coupled with a user device that is associated with the cellular network.

In one embodiment, the validating of the identifier (to check if is associated with the cellular network 8) comprises validating whether the user device 2 is directly connected to the cellular network 8. Directly connected here implies that it is the user device itself that is a user device of the cellular network, i.e. the user device is not connected to the cellular network via an intermediate tethering device or cellular modem (connected to the cellular network and providing access to the cellular network for local devices using local wireless (and/or wired) connectivity).

Alternatively, the validating accepts also a connection via a tethering device or cellular modem.

The detection of whether the user device is a tethered device can e.g. be implemented by querying a session management function (SMF) of the cellular network, based on the session identifier.

In the generate token step 46, the authentication server 1 generates an authentication token, comprising cryptographically applying a key of the authentication server 1, e.g. by encryption or cryptographic signing. The resulting authentication token is a data item. The key can be what is commonly referred to as a secret key of a cryptographic keypair, consisting of a secret key (sometimes referred to as a private key) and a public key. It is to be noted that the generation of the token does not require complete secrecy of the secret key, as long as the secret key has not been exposed to the third-party application server. The secret key is in one embodiment a home network private key, where the user device 2 has access to the corresponding home network public key, e.g. through prior provisioning of the home network public key in a UICC in the user device 2. In another embodiment, the secret key is a key especially stored in the authentication server 1 only for the generation of the authentication token of this invention.

In one embodiment, the generating of the authentication token is only performed after successfully validating that the identifier is associated with the cellular network.

In a provide token step 48, the authentication server 1 provides the authentication token to the user device 2.

Since the token is received over the cellular network 8, this enables the authentication server 1 to check if the identifier is associated with the cellular network 8. Since the user device is already identified and authenticated with the cellular network 8, this authentication is used as an authentication base for extending to the third-party application using the authentication token. This results in a very user-friendly experience, where the user is relieved from providing any login details, such as passwords, for the authentication token to be generated.

In other words, when the user starts a client application, the authentication is transparent and implicit for the user—the web page will redirect to a login interface which will automatically determine the user identity based on the identifier being associated with the cellular network and thus access.

The connection to the WAN 6 via the access point 12 can be used for all traffic for the user device except for communication for obtaining the authentication token from the authentication server 1, which is routed via the cellular network 8. However, it is to be noted that the authentication over the cellular network 8 only needs a very low bandwidth since the exchange for the authentication can be achieved in the order of 10 kB.

Looking now to FIG. 3B, only steps that are new or modified compared to the disclosure illustrated by FIG. 3A are described.

In an optional receive set of valid identifier(s) step 39, the authentication server 1 receives (e.g. from the core network node 3) a set of at least one valid identifier that is associated with the cellular network. The set is stored in a local list of identifiers that are associated with the cellular network. This step can occur either on a regular basis or whenever changes (additions, deletions) are made to that list. The set of at least one valid identifier can be a complete list of current identifiers that are associated with the cellular network, or the set can contain changes that are made, i.e. one or more new identifiers that are associated with the cellular network (e.g. after attaching to the cellular network) and/or one or more identifiers that no longer are associated with the cellular network, and are then deleted from the locally stored list by the authentication server.

When the receive set of valid identifier(s) step 39 is performed, this implements a push-based information flow of association between identifiers and the cellular network 8, whereby the core network device 3 initiates communication of one or more identifiers that are associated with the cellular network 8. In this case, the conditional validation of identifier ok step 42 comprises checking if the identifier in the token request is in the local list of identifiers that are associated with the cellular network.

In an optional receive token from server application step 50, the authentication server 1 receives the authentication token from a server application. This occurs when the user device has provided the authentication token to the server application and the server application needs to authenticate the user, which is based on the server application providing the authentication token to the authentication server 1.

In an optional validate token step 52, the authentication server 1 validates 52 the authentication token. This can e.g. be performed by decrypting the authentication token and verifying its content.

In an optional provide validation result step 54, the authentication server 1 provides, to the server application, a result of the validation of the authentication token. In other words, the authentication server 1 reports if the validation was successful or not to the server application.

Alternatively, instead of the authentication server validating the token in steps 50, 52 and 54, as shown in FIG. 3B, the server application can validate the authentication token by verifying a signature in the authentication token using a public key of the authentication server.

Looking now to FIG. 3C, it is there illustrated optional sub-steps of the conditional validation of identifier ok step 42 of FIGS. 3A-C. This embodiment implements a pull-based verification of the identifier of the token request (in contrast to the push-based verification implemented by step 39 and the modified step 42 as described above with reference to FIG. 3B).

In an optional transmit evaluation request sub-step 42a, the authentication server 1 transmits an evaluation request to a core network device 3. The evaluation request comprising the identifier. This is a query to the core network device 3 to check if the identifier is associated with the cellular network.

In an optional receive evaluation result sub-step 42b, the authentication server 1 receives, from the core network device 3, a result indicating whether the identifier is associated with the cellular network 8.

FIG. 4 is a flow chart illustrating embodiments of methods for enabling providing an authentication token for user authentication for a third-party application. The method is performed by a core network device 3 of a cellular network 8 also comprising an authentication server 1.

In an attach user device step 140, the core network device 3 attaches a user device 2 to the cellular network 8. This implies that the user device 2 connects to the network and can establish communication channels via the cellular network 8, for uplink and/or downlink communication.

In a modify configuration for routing step 142, the core network device 3 modifies a configuration such that any subsequent request from the user device 2 to the authentication server 1 (e.g. for an authentication token) <, are routed via the cellular network 8. This routing can e.g. be achieved by, when the user device 2 supports a first connection via the cellular network 8 in parallel with a second connection via a second network (such as the WAN 6 via the access point 12), adding a latency for connections to the authentication server 1 over the second connection. In this way, the introduced latency directs the user device to primarily connect via cellular network for communication with the authentication server 1, while the user device is free to connect via the second network for other traffic (where no latency is introduced), since the user device selects network based on latency. This can be based on MPTCP (multipath transport control protocol), or MPQUIC (multipath quic).

Alternatively, the routing from the user device 2 to the authentication server 1 is configured to use the cellular network 8 using PDP (packet data protocol) configuration. Alternatively, the routing is configured using separate client software that manipulates IP routes (such as device management software).

Alternatively, the routing is configured via a combination of VPN (virtual private network) and the cellular interface, using a VPN on top of the cellular network connection. This enables the routing to be implemented in a relatively simple way.

In a receive evaluation request step 144, the core network device 3 receives an evaluation request comprising an identifier at least temporarily associated with the user device 2. The evaluation request can be received from the authentication server 1, e.g. transmitted in sub-step 42a mentioned above.

In an evaluate identifier step 146, the core network device 3 evaluates whether the identifier is associated with the cellular network 8. This can e.g. be based on a session identifier, IP address and/or subscriber identifier.

In a transmit result step 148, the core network device 3 transmits a result of the evaluating, i.e. whether the identifier is associated with the cellular network 8 or not. The result can be transmitted to the authentication server 1.

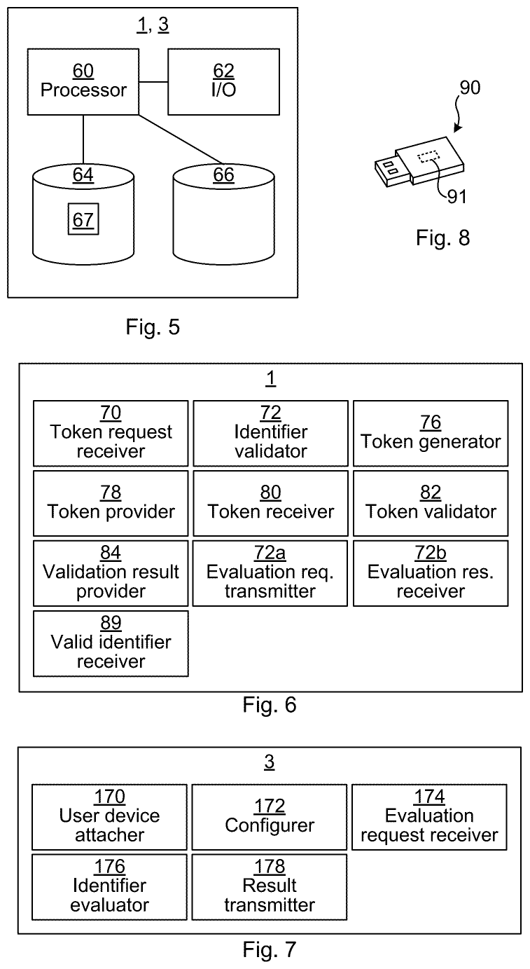

FIG. 5 is a schematic diagram illustrating components of each one of the authentication server 1 and the core network device 3 of FIG. 1. A processor 60 is provided using any combination of one or more of a suitable central processing unit (CPU), graphics processing unit (GPU), multiprocessor, microcontroller, digital signal processor (DSP), etc., capable of executing software instructions 67 stored in a memory 64, which can thus be a computer program product. The processor 60 could alternatively be implemented using an application specific integrated circuit (ASIC), field programmable gate array (FPGA), etc. The processor 60 can be configured to execute the method described with reference to FIGS. 3A-C (for the authentication server 1) and FIG. 4 (for the core network device 3) above.

The memory 64 can be any combination of random-access memory (RAM) and/or read-only memory (ROM). The memory 64 also comprises non-transitory persistent storage, which, for example, can be any single one or combination of magnetic memory, optical memory, solid-state memory or even remotely mounted memory.

A data memory 66 is also provided for reading and/or storing data during execution of software instructions in the processor 60. The data memory 66 can be any combination of RAM and/or ROM.

An I/O interface 62 is provided for communicating with external and/or internal entities using wired communication, e.g. based on Ethernet, optical fibre connections, and/or wireless communication, e.g. Wi-Fi, and/or a cellular network, as long as the principles described herein are applicable.

Other components of the authentication server 1 and the core network device 3 are omitted in order not to obscure the concepts presented herein.

FIG. 6 is a schematic diagram showing functional modules of the authentication server 1 of FIG. 1 according to one embodiment. The modules are implemented using software instructions such as a computer program executing in the authentication server 1. Alternatively or additionally, the modules are implemented using hardware, such as any one or more of an ASIC (Application Specific Integrated Circuit), an FPGA (Field Programmable Gate Array), or discrete logical circuits. The modules correspond to the steps in the methods illustrated in FIGS. 3A-C.

A token request receiver 70 corresponds to step 40. An identifier validator 72 corresponds to step 42. A token generator 76 corresponds to step 46. A token provider 78 corresponds to step 48. A token receiver 80 corresponds to step 50. A token validator 82 corresponds to step 52. A validation result provider 84 corresponds to step 54. An evaluation request transmitter 72a corresponds to step 42a. An evaluation result receiver 72b corresponds to step 42b. A valid identifier receiver 89 corresponds to step 39.

FIG. 7 is a schematic diagram showing functional modules of the core network device 3 of FIG. 1 according to one embodiment. The modules are implemented using software instructions such as a computer program executing in the core network device 3. Alternatively or additionally, the modules are implemented using hardware, such as any one or more of an ASIC (Application Specific Integrated Circuit), an FPGA (Field Programmable Gate Array), or discrete logical circuits. The modules correspond to the steps in the methods illustrated in FIG. 4.

A user device attacher 170 corresponds to step 140. A configurer 172 corresponds to step 142. An evaluation request receiver 174 corresponds to step 144. An identifier evaluator 176 corresponds to step 146. A result transmitter 178 corresponds to step 148.

FIG. 8 shows one example of a computer program product 90 comprising computer readable means. On this computer readable means, a computer program 91 can be stored in a non-transitory memory. The computer program can cause a processor to execute a method according to embodiments described herein. In this example, the computer program product is in the form of a removable solid-state memory, e.g. a Universal Serial Bus (USB) drive. As explained above, the computer program product could also be embodied in a memory of a device, such as the computer program product 64 of FIG. 5. While the computer program 91 is here schematically shown as a section of the removable solid-state memory, the computer program can be stored in any way which is suitable for the computer program product, such as another type of removable solid-state memory, or an optical disc, such as a CD (compact disc), a DVD (digital versatile disc) or a Blu-Ray disc.

Here now follows a list of embodiments enumerated with roman numerals.

i. A method for providing an authentication token for authentication of a user device for a third-party application, the method being performed by an authentication server associated with a first network, the method comprising:
receiving a request for an authentication token from a user device over a channel in the first network, the request comprising an identifier at least temporarily associated with the user device;
validating that the identifier is associated with the first network;
generating an authentication token, comprising cryptographically applying a key of the authentication server, resulting in an authentication token being a data item; and
providing the authentication token to the user device.

ii. The method according to embodiment i, wherein the generating of the authentication token is only performed after successfully validating that the identifier is associated with the first network.

iii. The method according to any one of the preceding embodiments, wherein the first network is a cellular network and the validating comprises:
transmitting an evaluation request to a core network device of the cellular network, the evaluation request comprising the identifier; and
receiving from the core network device a result indicating whether the identifier is associated with the cellular network.

iv. The method according to embodiment i or ii, wherein the first network is a wireless local area network (such as WiFi).

In embodiment iv, the validating can be based on the user device having authenticated with the wireless local area network with user specific credentials and/or a user-device specific certificate stored in the user device. This allows the authentication server to evaluate whether the user device is associated with the first network.

v. The method according to any one of the preceding embodiments, wherein the identifier comprises an Internet Protocol, IP, address, and wherein the step of validating comprises matching the IP address against a list of IP addresses associated with the first network.

vi. The method according to any one of the preceding embodiments, wherein the identifier comprises a session identifier, identifying a session for the user device in relation to the first network, and wherein the validating comprises determining that the session identifier is associated with the first network.

vii. The method according to any one of the preceding embodiments, wherein the identifier comprises a subscriber identifier associated with the user device.

viii. The method according to any one of the preceding embodiments, further comprising:

receiving the authentication token from a server application;
validating the authentication token; and
providing, to the server application, a result of the validation of the authentication token.

ix. The method according to any one of the preceding embodiments, wherein the validating comprises ensuring that the user device is directly connected to the cellular network.

x. An authentication server configured to form part of a first network for providing an authentication token for authentication of a user device for a third-party application, the authentication server comprising:
a processor; and
a memory storing instructions that, when executed by the processor, cause the authentication server to:
   receive a request for an authentication token from a user device over a channel in the first network, the request comprising an identifier at least temporarily associated with the user device;
   validate that the identifier is associated with the first network;
   generate an authentication token, comprising cryptographically applying a key of the authentication server, resulting in an authentication token being a data item; and
   provide the authentication token to the user device.

xi. A computer program for providing an authentication token for authentication of a user device for a third-party application, the computer program comprising computer program code which, when executed on an authentication server of a first network causes the authentication server to:
receive a request for an authentication token from a user device over a channel in the first network, the request comprising an identifier at least temporarily associated with the user device;
validate that the identifier is associated with the first network;
generate an authentication token, comprising cryptographically applying a key of the authentication server, resulting in an authentication token being a data item; and
provide the authentication token to the user device.

xii. A computer program product comprising a computer program according to claim xi and a computer readable means comprising non-transitory memory in which the computer program is stored.

The aspects of the present disclosure have mainly been described above with reference to a few embodiments. However, as is readily appreciated by a person skilled in the art, other embodiments than the ones disclosed above are equally possible within the scope of the invention, as defined by the appended patent claims. Thus, while various aspects and embodiments have been disclosed herein, other aspects and embodiments will be apparent to those skilled in the art. The various aspects and embodiments disclosed herein are for purposes of illustration and are not intended to be limiting, with the true scope and spirit being indicated by the following claims.

1.-26. (canceled)

27. A method for providing an authentication token for authentication of a user device for a third-party application, the method being performed by an authentication server of a cellular network, the method comprising:
receiving a request for an authentication token from a user device over a channel in the cellular network, the request comprising an identifier at least temporarily associated with the user device;
validating that the identifier is associated with the cellular network, wherein the validating comprises:
transmitting an evaluation request to a core network device, the evaluation request comprising the identifier; and
receiving from the core network device a result indicating whether the identifier is associated with the cellular network; generating an authentication token, comprising cryptographically applying a key of the authentication server, resulting in an authentication token being a data item; and
providing the authentication token to the user device.

28. The method according to claim 27, wherein the generating of the authentication token is only performed after successfully validating that the identifier is associated with the cellular network.

29. The method according to claim 27, further comprising:
receiving a set of at least one valid identifier that is associated with the cellular network and storing in a local list of identifiers that are associated with the cellular network;
and wherein the validating comprises verifying that identifier is in the local list of identifiers that are associated with the cellular network.

30. The method according to claim 27, wherein the identifier comprises an Internet Protocol, IP, address, and wherein the validating comprises matching the IP address against a list of IP addresses associated with the cellular network.

31. The method according to claim 27, wherein the identifier comprises a session identifier, identifying a session for the user device in relation to the cellular network, and wherein the validating comprises determining that the session identifier is associated with the cellular network.

32. The method according to claim 27, wherein the identifier comprises a subscriber identifier associated with the user device.

33. The method according to claim 27, further comprising:
receiving the authentication token from a server application;
validating the authentication token; and
providing, to the server application, a result of the validation of the authentication token.

34. The method according to claim 27, wherein the validating comprises ensuring that the user device is directly connected to the cellular network.

35. An authentication server configured to form part of a cellular network for providing an authentication token for authentication of a user device for a third-party application, the authentication server comprising:
a processor; and
a memory storing instructions that, when executed by the processor, cause the authentication server to:
receive a request for an authentication token from a user device over a channel in the cellular network, the request comprising an identifier at least temporarily associated with the user device;
validate that the identifier is associated with the cellular network, wherein the instructions to validate comprise instructions that, when executed by the processor, cause the authentication server to:
transmit an evaluation request to a core network device, the evaluation request comprising the identifier; and
receive from the core network device a result indicating whether the identifier is associated with the cellular network; generate an authentication token, comprising cryptographically applying a key of the authentication server, resulting in an authentication token being a data item; and
provide the authentication token to the user device.

36. The authentication server according to claim 35, wherein the instructions to generate the authentication token comprise instructions that, when executed by the processor, cause the authentication server to only generate the authentication token after successfully validating that the identifier is associated with the cellular network.

37. The authentication server according to claim 35, further comprising instructions that, when executed by the processor, cause the authentication server to:
receive a set of at least one valid identifier that is associated with the cellular network and storing in a local list of identifiers that are associated with the cellular network;
and wherein the instructions to validate comprise instructions that, when executed by the processor, cause the authentication server to: verify that identifier is in the local list of identifiers that are associated with the cellular network.

38. The authentication server according to claim 35, wherein the identifier comprises an Internet Protocol, IP, address, and wherein the instructions to validate comprise instructions that, when executed by the processor, cause the authentication server to match the IP address against a list of IP addresses associated with the cellular network.

39. The authentication server according to claim 35, wherein the identifier comprises a session identifier, identifying a session for the user device in relation to the cellular network, and wherein the instructions to validate comprise instructions that, when executed by the processor, cause the authentication server to determine that the session identifier is associated with the cellular network.

40. The authentication server according to claim 35, wherein the identifier comprises a subscriber identifier associated with the user device.

41. The authentication server according to claim 35, further comprising instructions that, when executed by the processor, cause the authentication server to:
receive the authentication token from a server application;
validate the authentication token; and
provide, to the server application, a result of the validation of the authentication token.

42. The authentication server according to claim 35, wherein the instructions to validate comprise instructions that, when executed by the processor, cause the authentication server to ensure that the user device is directly connected to the cellular network.

43. A method for enabling providing an authentication token for user authentication for a third-party application, the method being performed by a core network device of a cellular network also comprising an authentication server, the method comprising:
attaching a user device to the cellular network;
modifying a configuration such that any subsequent request from the user device to the authentication server for an authentication token, are routed via the cellular network,
wherein modifying the configuration comprises, when the user device supports a first connection via the cellular network in parallel with a second connection via a second network, adding a latency for connections to the authentication server over the second connection;
receiving, from the authentication server, an evaluation request comprising an identifier at least temporarily associated with the user device;
evaluating whether the identifier is associated with the cellular network; and
transmitting a result of the evaluating.

44. A core network device configured to form part of a cellular network also comprising an authentication server, for enabling providing an authentication token for user authentication for a third-party application, the core network device comprising:
a processor; and
a memory storing instructions that, when executed by the processor, cause the core network device to:
attach a user device to the cellular network;
modify a configuration such that any subsequent request from the user device to the authentication server for an authentication token, are routed via the cellular network, wherein the instructions to modify a configuration comprise instructions that, when executed by the processor, cause the core network device to, when the user device supports a first connection via the cellular network in parallel with a second connection via a second network, add a latency for connections to the authentication server over the second connection;
receive, from the authentication server, an evaluation request comprising an identifier at least temporarily associated with the user device;
evaluate whether the identifier is associated with the cellular network; and
transmit a result of the evaluating.
